(19) United States
(12) Patent Application Publication
(10) Pub. No.: US 2015/0039587 A1
(43) Pub. Date: Feb. 5, 2015

(54) GENERIC SQL ENHANCEMENT TO QUERY ANY SEMI-STRUCTURED DATA AND TECHNIQUES TO EFFICIENTLY SUPPORT SUCH ENHANCEMENTS

(71) Applicant: Oracle International Corporation, Redwood Shores, CA (US)

(72) Inventors: ZHEN HUA LIU, San Mateo, CA (US); BEDA HAMMERSCHMIDT, Los Gatos, CA (US)

(21) Appl. No.: 14/337,189

(22) Filed: Jul. 21, 2014

Related U.S. Application Data
(60) Provisional application No. 61/860,848, filed on Jul. 31, 2013.

(51) Int. Cl. G06F 17/30

(52) U.S. Cl. CPC G06F 17/30935
USPC 707/718

(57) ABSTRACT

The approaches described herein provide an efficient way for a database server to support storage and retrieval for any of a growing number of semi-structured data formats. In one embodiment, a set of generic semi-structured data operators are provided that enable users to query, update, and validate data stored in any of a number of semi-structured data formats. In this context, a “generic” semi-structured data operator means a data operator that may be configured to operate on any number of different semi-structured data formats. For example, according to one embodiment, the same set of generic semi-structured data operators may be used to operate on data stored according to the XML, JSON, or any number of other semi-structured data formats.

### CROSS-REFERENCE TO RELATED APPLICATIONS

### Benefit Claim

This application claims the benefit of U.S. Provisional Application No. 61/860,848, filed Jul. 31, 2013, the entire contents of which is hereby incorporated by reference as if fully set forth herein, under 35 U.S.C. §119(e).

### FIELD OF THE DISCLOSURE

The present disclosure relates generally to enhancements for supporting the storage and manipulation of semi-structured data in relational database environments.

### BACKGROUND

Relational database management systems (RDBMSs) have been very successful in providing data management for structured data. However, while RDBMSs have become the standard for storing and manipulating structured data, semi-structured data formats are becoming increasingly popular for describing and storing data across a wide variety of applications. Semi-structured data is data in which the values of semantic elements contained in the data may be marked and/or delineated by tags or other markers that organize and possibly describe the semantic elements, but which may not conform to a more formal data model such as a relational data model typically associated with relational databases. Examples of widely used semi-structured data formats include the Extensible Markup Language (XML) and JavaScript Object Notation (JSON).

Because semi-structured data may not conform to any particular formal structure, the storage of semi-structured data in an RDBMS presents a number of challenges. First, relational databases rely on a relational data model which expects data to have a defined and static schema before data can be stored and manipulated. Second, management of data in an RDBMS commonly is implemented using the Structured Query Language (SQL); however, SQL is not designed with native functionality for querying semi-structured data. Instead, semi-structured data formats typically may be associated with separate data format-specific query languages such as XQuery for XML-formatted data and JSONPath for JSON-formatted data.

In order to address these issues and others, separate standards have evolved or are currently evolving to provide support in RDBMSs for particular semi-structured data formats. For example, standards such as SQL/XML for XML data and SQL/JSON for JSON data have been developed or are currently under development to provide the ability to query data stored in RDBMSs based on those particular semi-structured data formats. Standards such as SQL/XML typically provide a set of SQL-based operators that enable users to manage certain semi-structured data formats stored in an RDBMS.

Format-specific standards such as SQL/XML have been successful in enabling users to manage particular semi-structured data formats stored in an RDBMS. However, a format-specific standard is applicable only to a particular semi-structured data format and generally is not extendable to managing other semi-structured data formats that may gain in popularity in the future. In one approach, new semi-structured data format-specific data types and operators could be developed to enable users to manage each newly introduced semi-structured data format. However, adding a new data format-specific data type and set of operators each time a new semi-structured data format is introduced is expensive from both a standards adoption and an RDBMS implementation perspective. Furthermore, many RDBMS clients (e.g., JDBC, ODP, and database import/export functions) may require modification to provide client operability with each new data format-specific data type and set of operators added.

The approaches described in this section are approaches that could be pursued, but not necessarily approaches that have been previously conceived or pursued. Therefore, unless otherwise indicated, it should not be assumed that any of the approaches described in this section qualify as prior art merely by virtue of their inclusion in this section.

### BRIEF DESCRIPTION OF THE DRAWINGS

In the drawings:

FIG. 1 is a flow diagram showing steps for processing a query expression including a generic semi-structured data operator;

FIG. 2 is a flow diagram showing steps for compiling a semi-structured data expression contained in a database query using a semi-structured data format-specific implementation module;

FIG. 3 is a block diagram that illustrates a computer system upon which an embodiment of the invention may be implemented.

### DETAILED DESCRIPTION

In the following description, for the purposes of explanation, numerous specific details are set forth in order to provide a thorough understanding of the various inventive embodiments. It will be apparent, however, to one skilled in the art that the present invention may be practiced without these specific details.

1.0 GENERAL OVERVIEW

2.0 EXAMPLE IMPLEMENTATION
2.1 OPERATORS FOR QUERYING SEMI-STRUCTURED DATA
   2.1.1 VALUE OPERATOR
   2.1.2 EXISTS OPERATOR
   2.1.3 QUERY OPERATOR
   2.1.4 VALIDITY OPERATOR
   2.1.5 TABLE FUNCTION
2.2 OPERATORS FOR GENERATING SEMI-STRUCTURED DATA FROM RELATIONAL DATA
   2.2.1 OBJECT OPERATOR
   2.2.2 AGGREGATION OPERATOR
2.3 OPERATORS FOR UPDATING SEMI-STRUCTURED DATA
   2.3.1 UPDATE OPERATOR
2.4 TECHNIQUES FOR EFFICIENTLY SUPPORTING GENERIC SEMI-STRUCTURED OPERATORS IN A DATABASE SERVER
   2.4.1 OPERATOR IMPLEMENTATION
   2.4.2 OPERATOR MODES
   2.4.3 OTHER ENHANCEMENTS

3.0 HARDWARE OVERVIEW

### 1.0 General Overview

The approaches described herein provide an efficient way for a database server to support storage and retrieval for any of a growing number of semi-structured data formats. In one embodiment, a set of generic semi-structured data operators are provided that enable users to query, update, and validate data stored based on any of a number of semi-structured data formats. In this context, a “generic” semi-structured data operator refers a data operator configured to operate on any number of different semi-structured data formats. For example, according to one embodiment, the same set of generic semi-structured data operators may be used to operate on data stored according to the XML, JSON, and any number of other semi-structured data formats.

In an embodiment, the use of generic semi-structured data operators allows users to store semi-structured data in database tables using a standard data type (e.g., varchar, varbinary, CLOB, or BLOB data types). After storing semi-structured data into database tables using a standard data type, the generic semi-structured data operators enable users to specify semi-structured query languages expressions to carry out desired operations against the underlying semi-structured data.

The approaches described herein generalize and simplify semi-structured data format-specific solutions such as the SQL/XML standard for XML data and SQL/JSON implementation for JSON data. For example, by using a single set of generic data operators configured to operate on any number of different semi-structured data formats, the addition of a new format-specific data type and format-specific data operators each time support for a new semi-structured data format is desired may be avoided. Further, the generic semi-structured operators may be efficiently executed using approaches compatible with generic SQL engine processing. For example, once semi-structured data is managed by a database server using techniques such as those described herein, semi-structured data operations may take advantage of benefits provided by traditional database servers such as transactions, security, replication, partitioning, parallel execution, and operation completeness.

### 2.0 Implementation Examples

In one embodiment, a set of generic semi-structured data operators is provided enabling users to query, update, and validate data stored in a database based on any number of different semi-structured data formats. Further presented are techniques illustrating how the operators may be designed and implemented efficiently by a database server.

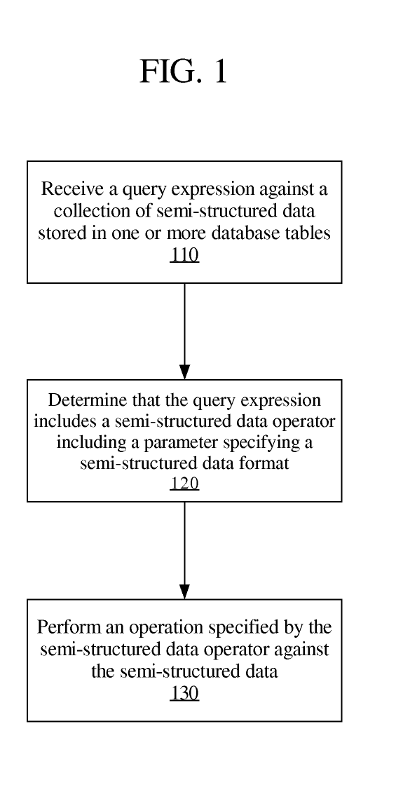

FIG. 1 is a flow diagram of steps for processing a query expression including a generic semi-structured data operator, according to an embodiment. Other embodiments do not include all the steps shown in FIG. 1. In Step 110, a database server receives a query including a generic semi-structured data operator. The query expression may be query against a collection of semi-structured data stored in one or more database tables. For example, the semi-structured data operator may be one of the generic semi-structured data operators described in more detail in separate sections hereinafter.

In Step 120, the database server determines that the query expression includes a semi-structured data operator. Determining that the query expression includes a semi-structured data operator may include identifying one or more parameters of the semi-structured data operator, including a parameter identifying a particular semi-structured data format. For example, a semi-structured data operator may include a parameter indicating that the query expression is against semi-structured data stored as XML data, JSON data, or based on any other semi-structured data format.

In Step 130, the database server performs an operation specified by the semi-structured data operator against the semi-structured data. For example, the operation may be a query operation to retrieve certain data, an update operation configured to update one or more components of semi-structured data stored in one or more tables, or an operation to verify whether specified data conforms to a particular semi-structured data format. The database server may perform the operation using a library developed for the particular semi-structured data format and/or for a particular semi-structured data query language. For example, the library may be a self-contained module that is registered with the database server, as described further herein.

### 2.1 Operators for Querying Semi-Structured Data

In one embodiment, a set of generic semi-structured data operators includes one or more operators configured to enable users to query semi-structured data stored in one or more database tables. For example, operators for querying semi-structured data may enable users to obtain a value from semi-structured data, to determine whether one or more conditions exist in semi-structured data, to extract certain data elements from stored data, and other operations described hereinafter.

2.1.1 Value Operator

In one embodiment, a set of generic semi-structured data operators may include a “value” operator. A value operator generally may be configured to apply a specified semi-structured data query language expression to semi-structured input data. The result of applying the semi-structured query language expression to the input data may be cast to a scalar value of a specified SQL built-in data type (e.g., varchar, CLOB, or LONG). For example, a value operator may be specified in a SQL SELECT, GROUP BY, ORDER BY clause, or any other SQL statement where a SQL built-in data type may be expected.

In an embodiment, input parameters to a semi-structured data value operator may include one or more of a name of a semi-structured data format, a name of an associated semi-structured query language, a semi-structured query language expression, a reference to semi-structured input data, a SQL built-in data type as output, and other options to control error handling behavior of the operator.

For example, the SQL statement below illustrates an example use of a semi-structured data value operator “SSD_VALUE”:

SELECT SSD_VALUE(‘JSON’, ‘json_path’, ‘$.person.address.city’,
PASSING t.jtext RETURNING VARCHAR(50) NULL ON ERROR)
FROM TAB t
ORDER BY SSD_VALUE(‘JSON’, ‘json_path’,
‘$.person.address.city’, PASSING t.jtext RETURNING VARCHAR(50)
NULL ON ERROR)

In the example, a value operator is used in the SELECT clause and includes the parameters “JSON”, “json_path”, and “$.person.address.city” specifying the name of a semi-structured data format, the name of a semi-structured query language, and a semi-structured query language expression, respectively. For example, the value operator in the SELECT clause may be configured to apply the “json_path” language expression “$.person.address.city” to the semi-structured input data stored in the jtext column of the table t. The result of applying the expression to the input data is cast to a SQL VARCHAR data type. Additionally, an error control option “NULL ON ERROR” is specified indicating that a NULL value is returned if an error occurs during the processing of the semi-structured query language expression.

The example query includes a second value operator in the ORDER BY clause. The second value operator includes the same parameters as the first value operator and may be used to sort the results of the SELECT clause using the native SQL ORDER BY operator.

Although the JSON data format is used in the example above and in other examples hereinafter, the use of the generic semi-structured data operators is not limited to JSON; in general, the semi-structured data operators described herein may be used to query, update, and validate data stored in any semi-structured data format.

2.1.2 Exists Operator

In one embodiment, a set of generic semi-structured data operators may include an “exists” operator. An exists operator generally may be configured to apply a specified semi-structured query language expression to semi-structured input data and to return a value based on whether one or more items are returned by the expression. If the result of evaluating the expression returns one or more data items, then the operator may return a SQL Boolean true value. If the result of evaluating the expression on the input data does not return any data items, then the operator may return a SQL Boolean false value.

For example, an exists operator may be used in a SQL WHERE clause or in a conditional expression of a SQL CASE expression where a SQL conditional expression is expected. An exists operator may be configured to retrieve one or more rows of a column storing semi-structured data and to determine if the data stored in each row satisfies one or more specified conditions. In one embodiment, input parameters to a semi-structured data exists operator may include one or more of a name of a semi-structured data format, a name of an associated semi-structured query language, a semi-structured query language expression, and a reference to semi-structured input data.

For example, the SQL statement below includes an example use of a semi-structured data exists operator “SSD_EXISTS”:

SELECT t.jtext
FROM TAB t
WHERE SSD_EXISTS(‘JSON’, ‘json_path’,
‘$.person.hobbies?.=”tennis”?’, PASSING t.jtext)

In the example query, the exists operator SSD_EXISTS includes parameters “JSON”, “json_path”, and “$.person.hobbies?.=“tennis”?” specifying the name of a semi-structured data format, the name of a semi-structured query language, and a semi-structured query language expression, respectively. During execution of the SSD_EXISTS operator, a database server may be configured to apply the “json_path” query language expression “$.person.hobbies?.=“tennis” ?” to one or more rows of the column t.jtext storing JSON text. The operator may return a Boolean true value, for example, for each row of the t.jtext column for which the predicate “$.person.hobbies?.=“tennis” ?” returns at least one data item. If the exists operator SSD_EXISTS return a Boolean true value for a particular row, then the row containing the JSON data may be returned by the SELECT clause; otherwise, the row is not returned.

2.1.3 Query Operator

In an embodiment, a set of generic semi-structured data operators may include a “query” operator. A query operator generally may be configured to apply a semi-structured query language expression to specified semi-structured input data and to cast the result of the evaluation to a specified SQL built-in data type. In an embodiment, input parameters to a query operator may include one or more of a semi-structured data format name, a name of an associated semi-structured query language, a semi-structured query language expression, a reference to the input semi-structured data, and a SQL built-in data type for output.

In an embodiment, a semi-structured data query operator may be used in SQL SELECT clauses. For example, a query operator may be used to extract one or more fragments of stored semi-structured data and to return the fragments as a specified SQL data type. In contrast to a value operator described above which is configured to return a scalar value from semi-structured data, a query operator may return formatted semi-structured data.

The following SQL statement illustrates an example use of a semi-structured data query operator “SSD_QUERY”:

SELECT SSD_QUERY(‘JSON’, ‘json_path’, ‘$.person.address’, PASSING
t.jtext RETURNING CLOB)
FROM TAB t

In the example, the query operator SSD_VALUE includes parameters “JSON”, “json_path”, “$.person.address” specifying the name of a semi-structured data format, the name of a semi-structured data query language, and a semi-structured data query language expression, respectively. For example, the SSD_QUERY may be configured to apply the “json_path” query language expression “$.person.address” to a column t.jtext storing JSON text, and to return the result of the evaluation as a CLOB containing semi-structured data representing instances of an “address” object found in the input data.

2.1.4 Validity Operator

In one embodiment, a set of generic semi-structured data operators may include a “validity” operator. A validity operator generally may be configured to validate semi-structured input data for conformity with a particular semi-structured data format. For example, a validity operator may return a Boolean true value if the operator determines that specified input data conforms to a particular semi-structured data format. Similarly, if a validity operator determines that specified input data fails to conform to a particular semi-structured data format, the operator may return a Boolean false value. A validity operator may be used, for example, as part of a SQL WHERE clause, or as part of a SQL CHECK constraint to verify input data before it is stored in a database column.

The following SQL statement illustrates an example use of a semi-structured validity operator “SSD_IS_VALID”:

SELECT COUNT(*)
FROM TAB t
WHERE SSD_ IS _VALID(t.varcharjtext,‘JSON’)

In the example, the validity operator SSD_IS_VALID is used in a WHERE clause and includes parameters “t.varcharjtext” and “JSON” specifying a column storing semi-structured data and the name of a semi-structured data format. For example, the SSD_IS_VALID operator in the WHERE clause may be configured to determine whether data stored in each row of the t.varcharjtext column is validly formatted as JSON data. For example, a validity check generally may include determining whether the stored data conforms to certain syntax requirements for a particular semi-structured data format. In the example query, if the SSD_IS_VALID operator returns a Boolean true value indicating that the data stored in a particular row is validly formatted, then the row may be included in the COUNT aggregation in the SELECT clause.

2.1.5 Table Function

In an embodiment, a set of generic semi-structured data operators may include a semi-structured data table function. A table function generally may be configured to map the result of a semi-structured query language expression into one or more relational rows and columns of a virtual table returned by the function. In other words, a semi-structured data table function may be configured to provide a relational projection of semi-structured data. For example, a table function may be included in a SQL FROM clause to create a source table from semi-structured data and which may be operated upon by a SELECT clause.

In an embodiment, a semi-structured data table function may include one or more parameters including a row expression and a set of column expressions. A row expression may specify a semi-structured query language expression to be applied to semi-structured input data, where the result of evaluating the expression is iterated as a set of rows. Each column expression may apply a semi-structured query language expression to the output rows from the row expression to create one or more columns of the table. The parameters to a table function may also include one or more of a name of a semi-structured data format and a name of an associated semi-structured query language.

For example, the SQL statement below includes an example of a semi-structured data table function “SSD_TABLE”:

```
SELECT vt.type, vt.number
FROM TAB t, SSD_TABLE(‘JSON’, ‘json_path’,
‘$.person.contact.phonelist’
PASSING t.jtext
  COLUMNS
    Type varchar(4) PATH ‘$.type’
    Number varchar(20) PATH ‘$.actual-number’) vt
ORDER BY vt.type
```

In the example above, the table function SSD_TABLE includes a “json_path” language row expression “$.person.contact.phonelist”, the evaluation of which is mapped into two varchar columns named “Type” and “Number” each storing JSON text data. The values stored in the two columns are obtained based on the respective column expressions “$.type” and “$.actual-number”. For example, evaluating the example statement may result in an array of phone lists. The resulting virtual table is aliased with the name “vt” which is also referenced in the SELECT clause.

As indicated above, a table function may include a row expression which generates a set of rows which are further operated upon by one or more column expressions to create one or more columns. In one embodiment, a semi-structured data table function may be configured such that a row expression passes a pointer or other reference to sub-components of the semi-structured data to the column expressions for further processing. In this manner, a table function may avoid passing a materialized form of semi-structured data from the row expression to the column expressions, thereby avoiding the overhead of materializing and sending the underlying semi-structured data for processing by the column expressions.

In an embodiment, a semi-structured table function may be chained in order to represent any hierarchical structure of semi-structured data such as a “master/detail” relationship between data items. An intermediate semi-structured data representation may be referenced using a SSD_REFERENCE special type which is used for chaining two or more table functions, but which may or may not be directly referenced in other parts of a SQL statement.

For example, the SQL statement below includes an example of chaining semi-structured data table functions based on a column “t.jtext” that stores JSON formatted information about purchase order line items and parts, where the line items and parts may exhibit a hierarchical relationship to one another:

```
SELECT vt.ItemName, vt2.partName
FROM TAB t, SSD_TABLE(‘JSON’, ‘json_path’,
‘$.purchaseorder.lineitem’
PASSING t.jtext
  COLUMNS
    ItemName varchar(40) PATH ‘$.itemName’
    part SSD_REFERENCE PATH ‘$.itemPart’) vt,
SSD_TABLE(‘JSON’, ‘json_path’, ‘$.parts’
PASSING vt.part
  COLUMNS
    partName varchar(20) PATH ‘$.partName’) vt2
ORDER BY vt.ItemName, vt2.partName
```

In this example, the first table function SSD_TABLE maps a result of evaluating the “json_path” expression “$.purchaseorder.lineitem” into a virtual table “vt” having columns named “ItemName” and “part.” The column expression creating the “part” column specifies that the data is to be stored as a SSD_REFERENCE special type. The “part” column of type SSD_REFERENCE is then able to be referenced by the second SSD_TABLE function using the “PASSING vt.part” parameter. In this manner, the hierarchical relationship between the “parts” and “partName” values may be extracted and stored in a relational format.

In one embodiment, a semi-structured data reference type, such as the example SSD_REFERENCE type described above, may be implemented by passing a reference to an event stream state to any subsequent table function that operates on the data. In this manner, other table functions may process the data in the event stream state without materializing intermediate result as another semi-structured data instance.

2.2 Operators for Generating Semi-Structured Data from Relational Data

In an embodiment, a set of generic semi-structured data operators may include one or more operators configured to generate semi-structured data from relational data. For example, operators for generating semi-structured data from relational data may include an object operator and an aggregation operator, described in more detail below.

2.2.1 Semi-Structured Data Object Operator

In one embodiment, a set of generic semi-structured data operators may include a semi-structured data “object” operator. A semi-structured data object operator generally may be configured to generate a data object representing semi-structured data based on a set of SQL expressions with associated expression names. The SQL expression names are used as structured “tagging” (e.g., tags that separate semantic elements in the semi-structured data) and the SQL expression values are used as values for the structured tagging.

For example, the following SQL statement illustrates an example of a semi-structured data object operator “SSD_OBJECT”:

SELECT SSD_OBJECT(‘JSON’, col1 AS “tag1”, col2 AS “tag2”)
FROM relational_tab /* col1, col2 are columns of the table
relational_tab */

In the example, the semi-structured object operator SSD_OBJECT is configured to generate, for each row of the relational table relational_tab, semi-structured data based on a structure specified by the JSON data format. For example, execution of the example statement may generate a JSON object that includes JSON formatted data such as {“tag1”:col1_val, “tag2”:col2_val} for each row of the table, where col1_val and col2_val represent the values of col1 and col2 in each row, respectively.

2.2.2 Aggregation Operator

In one embodiment, a set of generic semi-structured data operators may include an “aggregation” operator. An aggregation operator generally may be configured to generate an array of semi-structured data object instances by aggregating semi-structured data object instances generated from each row of a relational table.

A data model for a particular semi-structured data format may include not only a representation of semi-structured object data objects according to the particular format, but may also include the concept of a collection of semi-structured data objects. For example, an XQuery sequence is an example of such a collection for XML data; similarly, a JSON array is an example of such a collection for the JSON data format. Thus, whereas a semi-structured data object operator may return a semi-structured data object, an aggregation operator may be configured to return an array or collection of semi-structured data objects.

The following SQL statement illustrates an example use of a semi-structured data aggregation operator “SSD_OBJ_AGGREGATE”:

SELECT SSD_OBJ_AGGREGATE(SSD_OBJECT(‘JSON’, col1
AS “tag1”, col2 AS “tag2”))
FROM relational_tab /* col1, col2 are columns of the
relational_tab */

In the example, the semi-structured data object operator SSD_OBJECT is configured to generate semi-structured data objects based on the specified JSON format for each row of the relational table relational_tab. The aggregation operator SSD_OBJ_AGGREGATE may then generate a JSON array object containing elements {“tag1”:col1_val, “tag2”: col2_val} generated from each row of the relational table relational_tab.

In an embodiment, a semi-structured data aggregation operator which specifies a nested semi-structured data object operator, such as in the example above, may be evaluated using a “top-down” evaluation approach in order to avoid generating repeated copies of the semi-structured data object operator for operation by the parent aggregation operator. For example, evaluation of a semi-structured data aggregation operator may create one destination event stream that is passed to each nested semi-structured data object operator so that the object operators may write the results of the object operator into the event stream.

In one embodiment, a SQL statement that includes a semi-structured data aggregation operator and a semi-structured data table function may be algebraically optimized due to inverse nature of the operations performed by the operators. For example, an aggregation operator is configured to create semi-structured data from relational data, whereas a table function is configured to create relational data from semi-structured data. Similarly, a semi-structured data value operator and semi-structured data object operator represent inverse operations and may also be algebraically optimized during query optimization.

### 2.3 Operators for Updating Semi-Structured Data

In an embodiment, a set of generic semi-structured data operators may include one or more operators configured to update semi-structured data stored. For example, the operators may include an update operator, described in more detail hereinafter.

2.3.1 Update Operator

In an embodiment, a set of semi-structured data operators may include an “update” operator. An update operator generally may be configured to modify, insert, or delete specified components of semi-structured data stored in one or more tables of a database. In an embodiment, input parameters to an update operator may include one or more of a name of a semi-structured data format, a name of an associated semi-structured query language, and one or more particular update operations. Each update operation, for example, may specify a semi-structured query language expression identifying data to be updated and possibly other parameters depending on the type of update operation.

For example, the following SQL statement illustrates an example of a generic semi-structured data update operator SSD_UPDATE:

UPDATE tab t
SET t.jtext USING
SSD_UPDATE(‘json’, ‘json_path’,
set(‘$.person.firstname’, ‘john’),
set(‘$.person.lastname’, ‘smith’),
delete(‘$.person.salary’),
insert(‘$.person.phone’, ‘(555)555-8619’))

In the example, an update operator SSD_UPDATE is used as part of the SQL SET operator and is configured to apply semi-structured query language evaluations to the semi-structured input data to update, delete, and insert individual components of semi-structured data. The SSD_UPDATE operator in the example includes four separate operations for updating, deleting, and inserting data, indicated by the set, delete, and insert parameters. The result of applying the SSD_UPDATE operator may update the underlying semi-structured data stored in varchar, varbinary, CLOB or BLOB columns.

### 2.4 Techniques for Efficiently Supporting Generic Semi-Structured Operators in a Database Server

2.4.1 Operator Implementation

According to an embodiment, a set of generic semi-structured data operators as described herein may be implemented as native operators of a database server kernel. By implementing the operators as native operators rather than, for example, as user-defined functions, database performance may be increased. Similarly, according to one embodiment, a generic semi-structured data table function may be implemented as a native row source of a database server kernel and optimized to handle table-based operations. In general, a row source is an iterative control structure that processes a set of input rows (e.g., one or more rows of a source table containing semi-structured data) in an iterated manner and produces a set of output rows (e.g., one or more relational rows containing the processed semi-structured data).

In an embodiment, for each semi-structured data format and semi-structured data query language for which support is desired, a self-contained implementation module may be separately linked into a database server. In this context, a self-contained implementation module may expose a set of interfaces that a set of generic semi-structured data operators may invoke in order to carry out the operations of the generic semi-structured data operators for a particular semi-structured data format. A database server may provide a framework for the generic semi-structured data operators to invoke the implementation modules, which may be separately registered with the database server.

In an embodiment, a self-contained implementation module for a particular semi-structured data format includes a compiler interface configured to compile semi-structured query language expressions contained in a query. The compiler interface may be configured to store resulting plans for executing the semi-structured query language expressions as part of the execution plan for the SQL query that invokes one or more semi-structured operators containing the expressions. By implementing a compiler interface as part of the self-contained implementation module, a database server may avoid run-time compilation of semi-structured query language expressions on a per row basis. For example, if a query operates on many rows of a table and an operation on each row involves the same semi-structured query language expression, the compiler interface of an implementation module may be used to generate bytecode instructions for implementing the query language expression and the bytecode may be cached in the query plan for run time execution by the database server.

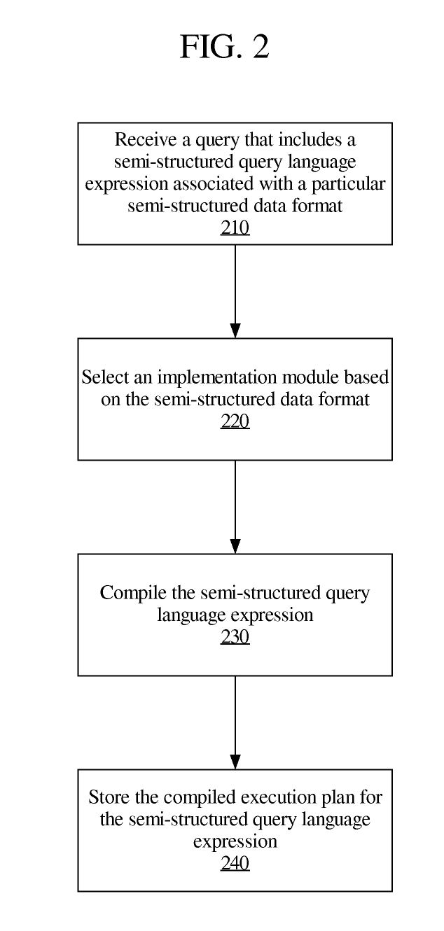

FIG. 2 is a flow diagram showing steps for compiling a semi-structured data expression contained in a database query using a semi-structured data format-specific implementation module. In Step 210, a database server receives a database query including a semi-structured query language expression associated with a particular semi-structured data format. The semi-structured query language expression, for example, may be specified as a parameter to a semi-structured data operator included in the query. The semi-structured data operator may, for example, include one of the operators described herein such as a value operator, exists operator, query operator, etc. In an embodiment, the particular semi-structured data format may also be specified as a parameter to the semi-structured data operator, or the data format may be determined based on the syntax of the query expression.

In Step 220, the database server selects a particular implementation module based on the semi-structured data format. For example, if the particular semi-structured data format is determined to be the JSON data format, the database server may select an implementation module that provides functionality for processing JSON query expressions. As another example, if the particular semi-structured data format is XML, an XML-specific implementation module may be selected. As described above, the various implementation modules may be separately linked into the database server depending on the types of semi-structured data to be processed.

In Step 230, the semi-structured query language expression is compiled to generate an execution plan for the expression. The execution plan provides a set of steps the database server may use to carrying out the specified processing steps against the semi-structured data specified in the query expression. As described above, each implementation module may include a compiler interface configured to receive and compile semi-structured query language expressions for a particular semi-structured data format.

In Step 240, an execution plan generated by the implementation module for the semi-structured query language expression is stored as part of a query execution plan for the query containing the semi-structured query language expression. As indicated above, by storing the execution plan for the semi-structured query language expression as part of the execution plan for the query containing the expression, runtime compilation of the data format-specific query expressions may be avoided.

2.4.2 Operator Modes

In an embodiment, a self-contained implementation module for a particular semi-structured data format may include a run time interface configured to return results of semi-structured query language expressions in one of three modes: “existence” mode, an “all mode”, and an “iterator” mode. The “existence” mode may be used, for example, by an exists operator and implemented using “lazy” evaluation techniques; for example, as soon as any results become available based on evaluating a semi-structured query language expression specified as a parameter to an exists operator, the exists operator can return a value without fully evaluating the semi-structured query language expression.

In contrast, an “all” mode may be used, for example, by a semi-structured data value operator or query operator. The all mode may be implemented using “eager” evaluation techniques; for example, the semantics of the value and query operators operate on entire semi-structured query language evaluation results and, thus, all data specified by the operators may be retrieved for each operator instance.

In an embodiment, an “iterator” mode may be used, for example, by a table function or other operator that generates a set of rows. The iterator mode may also be implemented using “lazy” evaluation techniques as the results available from a table function are typically consumed in an iterator fashion. For example, another operator calling a table function may stop consuming rows generated by the table function at any time based on criteria specified in the operator.

2.4.3 Other Enhancements

Semi-structured data may be represented in either a textual or binary form. Processing semi-structured data represented as text by parsing stored textual data during run time may be more expensive than operating on a binary form of the semi-structured data. In one embodiment, a database table may store both a textual representation of semi-structured data in one or more columns of a database table, and a corresponding binary representation of the same data may be stored in one or more hidden columns of the same table. The binary version of the data may be used in some instances for runtime processing instead of the textual version of the data. For example, a database server may provide the ability to process semi-structured data in binary form using a binary functional index over the base storage column of the textual semi-structured data.

In various embodiments, other native database functionality may be used to improve processing of certain semi-structured data operators. For example, functional indexes on a semi-structured data value operator and materialized relational views on a semi-structured data table function may be used to improve query response time in certain instances. As another example, inverted indexes may be created to index certain semi-structured data stored in one or more tables. An inverted index may be used, for example, to improve evaluation of a semi-structured data exists operator by indexing the data elements stored in a column of semi-structured data, thereby simplifying checks for certain data elements.

In an embodiment, evaluation of certain semi-structured query language statements such as those specified in a table function or exists operator, may use lazy evaluation techniques based on event stream processing of stored semi-structured data. For example, a semi-structured data table operator or exists operator may be configured to produce event streams from stored semi-structured data to facilitate lazy evaluation of the data.

### 3.0 Hardware Overview

According to one embodiment, the techniques described herein are implemented by one or more special-purpose computing devices. The special-purpose computing devices may be hard-wired to perform the techniques, or may include digital electronic devices such as one or more application-specific integrated circuits (ASICs) or field programmable gate arrays (FPGAs) that are persistently programmed to perform the techniques, or may include one or more general purpose hardware processors programmed to perform the techniques pursuant to program instructions in firmware, memory, other storage, or a combination. Such special-purpose computing devices may also combine custom hard-wired logic, ASICs, or FPGAs with custom programming to accomplish the techniques. The special-purpose computing devices may be desktop computer systems, portable computer systems, handheld devices, networking devices or any other device that incorporates hard-wired and/or program logic to implement the techniques.

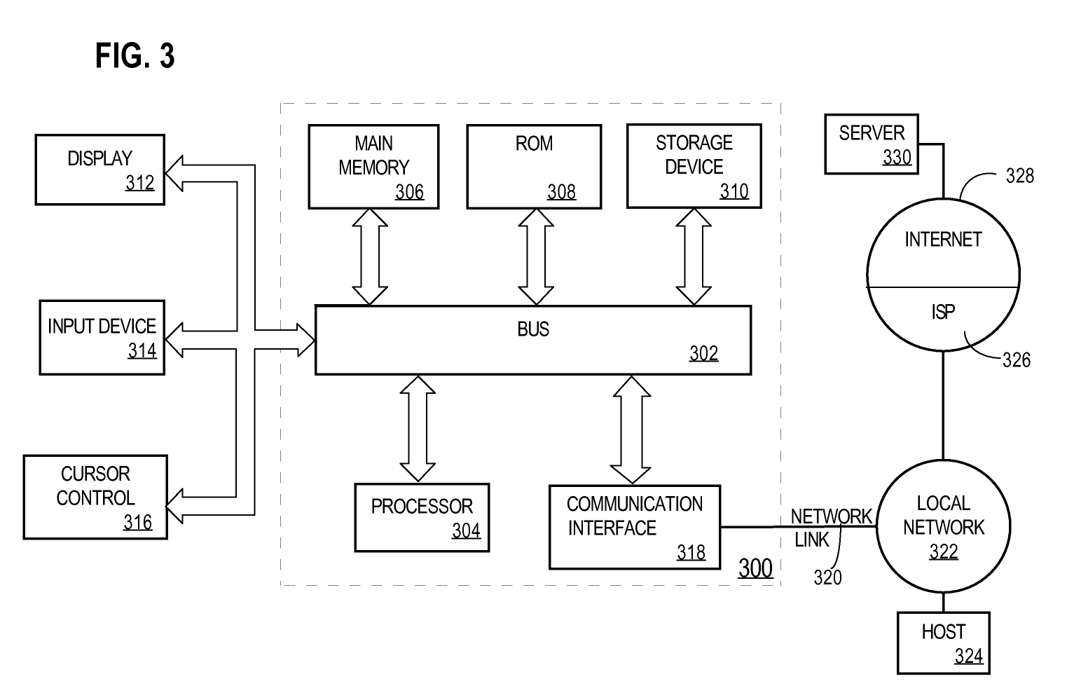

For example, FIG. 3 is a block diagram that illustrates a computer system 300 upon which an embodiment of the invention may be implemented. Computer system 300 includes a bus 302 or other communication mechanism for communicating information, and a hardware processor 304 coupled with bus 302 for processing information. Hardware processor 304 may be, for example, a general purpose microprocessor.

Computer system 300 also includes a main memory 306, such as a random access memory (RAM) or other dynamic storage device, coupled to bus 302 for storing information and instructions to be executed by processor 304. Main memory 306 also may be used for storing temporary variables or other intermediate information during execution of instructions to be executed by processor 304. Such instructions, when stored in non-transitory storage media accessible to processor 304, render computer system 300 into a special-purpose machine that is customized to perform the operations specified in the instructions.

Computer system 300 further includes a read only memory (ROM) 308 or other static storage device coupled to bus 302 for storing static information and instructions for processor 304. A storage device 310, such as a magnetic disk or optical disk, is provided and coupled to bus 302 for storing information and instructions.

Computer system 300 may be coupled via bus 302 to a display 312, such as a cathode ray tube (CRT), for displaying information to a computer user. An input device 314, including alphanumeric and other keys, is coupled to bus 302 for communicating information and command selections to processor 304. Another type of user input device is cursor control 316, such as a mouse, a trackball, or cursor direction keys for communicating direction information and command selections to processor 304 and for controlling cursor movement on display 312. This input device typically has two degrees of freedom in two axes, a first axis (e.g., x) and a second axis (e.g., y), that allows the device to specify positions in a plane.

Computer system 300 may implement the techniques described herein using customized hard-wired logic, one or more ASICs or FPGAs, firmware and/or program logic which in combination with the computer system causes or programs computer system 300 to be a special-purpose machine. According to one embodiment, the techniques herein are performed by computer system 300 in response to processor 304 executing one or more sequences of one or more instructions contained in main memory 306. Such instructions may be read into main memory 306 from another storage medium, such as storage device 310. Execution of the sequences of instructions contained in main memory 306 causes processor 304 to perform the process steps described herein. In alternative embodiments, hard-wired circuitry may be used in place of or in combination with software instructions.

The term “storage media” as used herein refers to any non-transitory media that store data and/or instructions that cause a machine to operation in a specific fashion. Such storage media may comprise non-volatile media and/or volatile media. Non-volatile media includes, for example, optical or magnetic disks, such as storage device 310. Volatile media includes dynamic memory, such as main memory 306. Common forms of storage media include, for example, a floppy disk, a flexible disk, hard disk, solid state drive, magnetic tape, or any other magnetic data storage medium, a CD-ROM, any other optical data storage medium, any physical medium with patterns of holes, a RAM, a PROM, and EPROM, a FLASH-EPROM, NVRAM, any other memory chip or cartridge.

Storage media is distinct from but may be used in conjunction with transmission media. Transmission media participates in transferring information between storage media. For example, transmission media includes coaxial cables, copper wire and fiber optics, including the wires that comprise bus 302. Transmission media can also take the form of acoustic or light waves, such as those generated during radio-wave and infra-red data communications.

Various forms of media may be involved in carrying one or more sequences of one or more instructions to processor 304 for execution. For example, the instructions may initially be carried on a magnetic disk or solid state drive of a remote computer. The remote computer can load the instructions into its dynamic memory and send the instructions over a telephone line using a modem. A modem local to computer system 300 can receive the data on the telephone line and use an infra-red transmitter to convert the data to an infra-red signal. An infra-red detector can receive the data carried in the infra-red signal and appropriate circuitry can place the data on bus 302. Bus 302 carries the data to main memory 306, from which processor 304 retrieves and executes the instructions. The instructions received by main memory 306 may optionally be stored on storage device 310 either before or after execution by processor 304.

Computer system 300 also includes a communication interface 318 coupled to bus 302. Communication interface 318 provides a two-way data communication coupling to a network link 320 that is connected to a local network 322. For example, communication interface 318 may be an integrated services digital network (ISDN) card, cable modem, satellite modem, or a modem to provide a data communication connection to a corresponding type of telephone line. As another example, communication interface 318 may be a local area network (LAN) card to provide a data communication connection to a compatible LAN. Wireless links may also be implemented. In any such implementation, communication interface 318 sends and receives electrical, electromagnetic or optical signals that carry digital data streams representing various types of information.

Network link 320 typically provides data communication through one or more networks to other data devices. For example, network link 320 may provide a connection through local network 322 to a host computer 324 or to data equipment operated by an Internet Service Provider (ISP) 326. ISP 326 in turn provides data communication services through the world wide packet data communication network now commonly referred to as the “Internet” 328. Local network 322 and Internet 328 both use electrical, electromagnetic or optical signals that carry digital data streams. The signals through the various networks and the signals on network link 320 and through communication interface 318, which carry the digital data to and from computer system 300, are example forms of transmission media.

Computer system 300 can send messages and receive data, including program code, through the network(s), network link 320 and communication interface 318. In the Internet example, a server 330 might transmit a requested code for an application program through Internet 328, ISP 326, local network 322 and communication interface 318.

The received code may be executed by processor 304 as it is received, and/or stored in storage device 310, or other non-volatile storage for later execution.

In the foregoing specification, embodiments of the invention have been described with reference to numerous specific details that may vary from implementation to implementation. The specification and drawings are, accordingly, to be regarded in an illustrative rather than a restrictive sense. The sole and exclusive indicator of the scope of the invention, and what is intended by the applicants to be the scope of the invention, is the literal and equivalent scope of the set of claims that issue from this application, in the specific form in which such claims issue, including any subsequent correction.

What is claimed is:

1. A method comprising:
receiving a query expression against a collection of semi-structured data stored in one or more tables of a database, wherein the query expression includes a generic semi-structured data operator;
wherein the semi-structured data operator includes a parameter specifying a particular semi-structured data format;
in response to receiving the query expression, performing an operation specified by the semi-structured data operator against the semi-structured data;
wherein the method is performed by one or more computing devices.

2. The method of claim 1, further comprising:
wherein the query expression is a first query expression and the semi-structured data format is a first semi-structured data format;
receiving a second query expression including the generic semi-structured data operator, wherein the semi-structured data operator specifies a second semi-structured data format that is different than the first semi-structured data format;
in response to receiving the second query expression, performing the operation against the semi-structured data.

3. The method of claim 1, wherein the semi-structured data operator is a value operator which applies a specified semi-structured data query language expression to specified input data, wherein applying the specified semi-structured data query language expression to the specified input data includes extracting a value from the specified input data and casting the value to a SQL data type.

4. The method of claim 1, wherein the semi-structured data operator is an exists operator which applies a specified semi-structured query language expression to input data and returns a value based on whether or not the expression returns one or more data items.

5. The method of claim 1, wherein the semi-structured data operator is a query operator which applies a semi-structured query language expression to input data and returns a result that is part of the input data.

6. The method of claim 1, wherein the semi-structured data operator is a validity operator which validates input data for conformity with a particular semi-structured data format.

7. The method of claim 1, wherein the semi-structured data operator is a table function which maps a result of one or more semi-structured query language expressions into one or more relational rows and columns.

8. The method of claim 1, wherein the semi-structured data operator is an object operator which generates a data object representing semi-structured output data, wherein the semi-structured output data is generated based on one or more SQL expressions.

9. The method of claim 1, wherein the semi-structured data operator is an update operator which modifies, inserts, or deletes one or more components of the semi-structured data.

10. The method of claim 1, wherein the semi-structured data operator is executed based on an implementation module associated with the particular semi-structured data format.

11. The method of claim 1, wherein the semi-structured data operator processes a set of input rows and produces a set of output rows.

12. The method of claim 10, wherein the implementation module includes a compiler interface configured to compile semi-structured query language expressions.

13. A non-transitory computer-readable medium storing instructions which, when executed by one or more processors, cause the one or more processors to perform a method, comprising:
receiving a query expression against a collection of semi-structured data stored in one or more tables of a database, wherein the query expression includes a generic semi-structured data operator;
wherein the semi-structured data operator includes a parameter specifying a particular semi-structured data format;
in response to receiving the query expression, performing an operation specified by the semi-structured data operator against the semi-structured data.

14. The non-transitory computer-readable medium of claim 13, further comprising:
wherein the query expression is a first query expression and the semi-structured data format is a first semi-structured data format;
receiving a second query expression including the generic semi-structured data operator, wherein the semi-structured data operator specifies a second semi-structured data format that is different than the first semi-structured data format;
in response to receiving the second query expression, performing the operation against the semi-structured data.

15. The non-transitory computer-readable medium of claim 13, wherein the semi-structured data operator is a value operator which applies a specified semi-structured data query language expression to specified input data, wherein applying the specified semi-structured data query language expression to the specified input data includes extracting a value from the specified input data and casting the value to a SQL data type.

16. The non-transitory computer-readable medium of claim 13, wherein the semi-structured data operator is an exists operator configured which applies a specified semi-structured query language expression to input data and returns a value based on whether or not the expression returns one or more data items.

17. The non-transitory computer-readable medium of claim 13, wherein the semi-structured data operator is a query operator which applies a semi-structured query language expression to input data and returns a result that is part of the input data.

18. The non-transitory computer-readable medium of claim 13, wherein the semi-structured data operator is a validity operator which validates input data for conformity with a particular semi-structured data format.

19. The non-transitory computer-readable medium of claim 13, wherein the semi-structured data operator is a table function which maps a result of one or more semi-structured query language expressions into one or more relational rows and columns.

20. The non-transitory computer-readable medium of claim 13, wherein the semi-structured data operator is an object operator which generates a data object representing semi-structured output data, wherein the semi-structured output data is generated based on one or more SQL expressions.

21. The non-transitory computer-readable medium of claim 13, wherein the semi-structured data operator is an update operator which modifies, inserts, or deletes one or more components of the semi-structured data.

22. The non-transitory computer-readable medium of claim 13, wherein the semi-structured data operator is executed based on an implementation module associated with the particular semi-structured data format.

23. The non-transitory computer-readable medium of claim 13, wherein the semi-structured data operator processes a set of input rows and produces a set of output rows.

24. The non-transitory computer-readable medium of claim 22, wherein the implementation module includes a compiler interface configured to compile semi-structured query language expressions.
